(19) United States
(12) Patent Application Publication
(10) Pub. No.: US 2006/0190538 A1
(43) Pub. Date: Aug. 24, 2006

(54) Method and apparatus for recognizing location of a home device using RFID

(75) Inventors: Yoo-seung Hwang, Seoul (KR); Dong-yun Shin, Seongnam-si (KR); Hun Lim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/312,364

(22) Filed: Dec. 21, 2005

(30) Foreign Application Priority Data
Feb. 18, 2005 (KR) 2005-13572

(51) Int. Cl. G06F 15/16

(52) U.S. Cl. 709/204

(57) ABSTRACT

A system where a home server can recognize a location of a home device in a home network. The home device includes a Radio Frequency Identification (RFID) tag which stores information about the home device, and each plug receptacle constituting the home network has an RFID reader. Accordingly, the RFID reader checks the location of the RFID tag in real time and transfers the information about the RFID tag and a receptacle identifier to a home server, so that the home server recognizes the location of the home device in real time using the information transferred. Therefore, using the transferred information, the home server can recognize in real-time the location of the home device, and also transfer necessary information to the home device.

### CROSS-REFERENCE TO RELATED APPLICATIONS

This application is based upon and claims the benefit of priority under 35 U.S.C. §119 from Korean Patent Application No. 2005-13572 filed on Feb. 18, 2005 in the Korean Intellectual Property Office, the entire content of which is incorporated herein by reference.

### BACKGROUND OF THE INVENTION

1. Field of the Invention

Devices, systems, and methods consistent with the invention relate to a home network, and more particularly, to efficiently controlling home devices by recognizing locations of home devices having a communicating function and home devices without a communicating function, as elements of a home network.

2. Description of the Related Art

A home network is a future home electronic appliance connection system which connects electronic appliances (e.g., a TV, a refrigerator, an air conditioner, etc.) at respective places in a house (e.g., a bedroom, a kitchen, a living room, an entrance, etc.) to the Internet, and therefore enables users to operate the connected electronic appliances by using a device such as a mobile phone.

Many uses of such a home network are possible. For example, if the home network is installed in a home, a home network user in the bedroom can identify a person ringing a doorbell, or a currently running cycle of a washing machine. Further, the home network user can monitor his house from outside the house, control the home's temperature from the office before leaving the office, and undergo a medical examination by using a PDA or the cellular phone. Still further, the television in the home can be automatically turned on to provide various kinds of information by recognizing the home network user through a fingerprint identification device. Still further, the home network user can check traffic states on a route to the office according to real-time traffic information provided from a traffic information service center, and thereby determine a route to the office.

The related art home network is implemented either by using a wired technique or a wireless technique. The wired technique includes home PNA, IEEE1394, PLC, Ethernet, etc., and the wireless technique includes Bluetooth, home RF, IrDA, etc. The wired home network technique has the benefit that it controls a PC, peripheral devices of the PC, information devices, digital electric appliances, etc. at a home using a single protocol. In comparison with the wired home network technique, the wireless technique has the benefit that it needs no cable and provides mobility of terminals. In addition, the wireless technique has the benefit that it allows a structure of the network to be easily changed, and that an installation process and a maintenance process can be more easily performed in comparison to the wired home network technique. On the other hand, the wireless technique has weak points such as a chance of transmission errors due to interference and attenuation of the same frequency, a problem of security, etc. Further with respect to the wireless technique, the home RF and Bluetooth use a radio wave method while the IrDA uses an infrared ray method. The infrared ray method has the benefit that it can prevent radio wave interference, but has a weak point that its effective range is reduced. In comparison with the infrared ray method, the radio wave method has a benefit of a wider effective range, but has a weak point that security is reduced.

FIG. 1 illustrates a related art home network. In accordance with FIG. 1, the home network includes a home server 100 and a plurality of home devices 110 to 116. In addition, the home network can include at least two home servers 100. Hereinafter, the general home network will be described in detail by referring to FIG. 1.

The home server 100 controls the home devices 110 to 116 included in the home network and the home devices 110 to 116 perform corresponding operations according to control commands from the home server 100. As shown in FIG. 1, the home server 100 recognizes locations of the home devices 110 to 116 in order to control efficiently the home devices 110 to 116. Namely, the home server 100 can transmit necessary control commands to the home devices 110 to 116 by recognizing the locations of the home devices 110 to 116.

However, the home devices 110 to 116 with middleware thereon can be connected to the home network or operated with the home network only when receiving electric power and performing a communication function. In addition, a home device operated by simple controls cannot load Universal Plug and Play (UPnP) middleware since the load due to the UPnP middleware is added to a CPU and a software of the home device. Still further, in a case of the home device on which the middleware is loaded, the home server 100 can recognize the operation of the home device connected to the home network, but cannot recognize the location of the home device in the home. Furthermore, the home server 100 cannot recognize the location of the home device within the home network if the home device does not have the communication function.

### SUMMARY OF THE INVENTION

It is a aspect of the invention to correctly recognize locations of the home devices, on which middlewares are loaded, by a home server, and to correctly recognize locations of the home devices of which the middleware is not loaded by the home server.

It is another aspect of the invention to correctly recognize the locations of the home devices in the home without adding loads to the home devices for performing simple control operations.

It is yet another aspect of the invention to efficiently control the home devices by using location information of the home devices as elements of a home network, which are recognized by the home server.

It is yet another aspect of the invention to allow the home server to control the home devices by recognizing the states of the home devices operated by a user.

According to an aspect of the present invention, there is provided a location recognition system for a home network, including: a home device comprising a Radio Frequency Identification (RFID) tag that stores information about the home device; and an RFID reader, at a first position, that receives the information stored on the RFID tag.

According to an aspect of the present invention, there is provided a home server, including: a communication module communicating with an RFID reader; and a database storing information about a home device obtained from an RFID tag on the home device via the RFID reader.

Hereinafter, RFID, as used for various devices or various products, will be described in detail before describing the home server and the home devices included in the home network of the invention. RFID is a system developed by a change in production methods, a change of consumer senses, innovation of culture and technology, and a requirement for solving weak points of a bar code and a magnetic card. RFID is a kind of contactless card and the term contactless card generally refers to RFID.

In comparison with a contact card, RFID does not require a user to waste time inserting an RFID tag into an RFID reader, prevents friction and damage due to the mechanical contact, and reduces influences of contamination and environment. The RFID reader continuously generates radio waves, while the RFID tag transmits an identifier and data to the RFID reader when the RFID tag approaches an effective range of the radio waves generated from the RFID reader. The RFID reader transmits the data received from the RFID tag to a server, which then compares the data stored into the database with the data received from the RFID reader and provides necessary services. At this time, in the signal transmission and reception processes, signals corresponding to a frequency band of 10 kHz to 300 GHz are used, and the low frequency of 134.2 kHz is mainly used. Hereinafter, properties of the RFID will be described in detail.

An RFID system saves time since it simultaneously recognizes a plurality of RFID tags. Thus, RFID is replacing the bar code or the magnetic tag in the field of physical distribution because of the first feature. Further, RFID also is easily applicable according to system properties and environmental conditions and can widen the applicable field. Thus, the RFID tag is replacing a contact smart card used in the conventional parking control system. Further, RFID systems also have a long lifetime since they has a prominent environment-resistant property. Thus, RFID has a low error rate under unfavorable conditions such as when the RFID tag is damaged due to friction, dust, moisture, temperature, snow, rain, and etc. since the user doesn't have to insert the RFID tag into the RFID reader and the RFID is not in mechanical contact. Accordingly, RFID is mainly applied to a systems in open space. Still further, RFID is able to pass through nonmetallic materials. Still further, RFID is able to recognize a moving body with high speed by a recognition method. Thus, RFID can be used in an unmanned parking management system or an automatic fare collection system of an expressway or a tunnel since the RFID reader can recognize the RFID tag within 0.01 to 0.1 second.

### BRIEF DESCRIPTION OF THE DRAWINGS

The above and other aspects of the invention will become more apparent by describing in detail exemplary embodiments thereof with reference to the attached drawings in which:

FIG. 1 is a diagram illustrating a home network including a home server and a plurality of home devices;

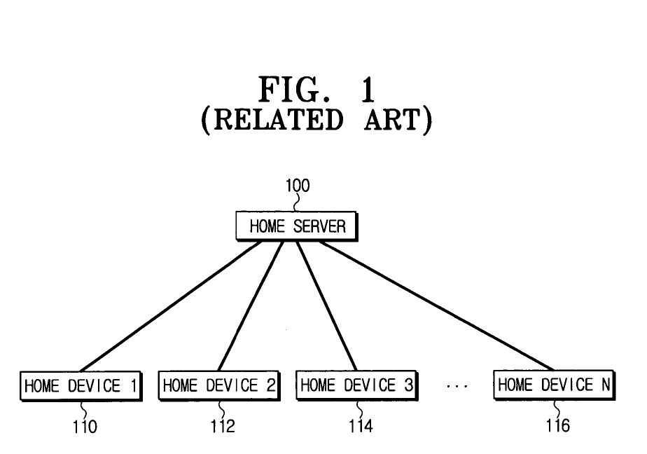

FIG. 2 is a diagram illustrating a home device having an RFID tag and a plug receptacle having an RFID reader according to an exemplary embodiment of the invention;

FIG. 3 is a block diagram illustrating elements of a home server according to an exemplary embodiment of the invention;

FIG. 4 is a flowchart illustrating operations performed between a plug receptacle and a home server according to an exemplary embodiment of the invention;

FIG. 5 is a flowchart illustrating operations of the plug receptacle according to an exemplary embodiment of the invention; and

FIG. 6 is a flowchart illustrating operations of the home server according to an exemplary embodiment of the invention.

### DETAILED DESCRIPTION OF EXEMPLARY EMBODIMENTS

Exemplary embodiments of the invention will now be described below by reference to the attached Figures. The described exemplary embodiments are intended to assist the understanding of the invention, and are not intended to limit the scope of the invention in any way.

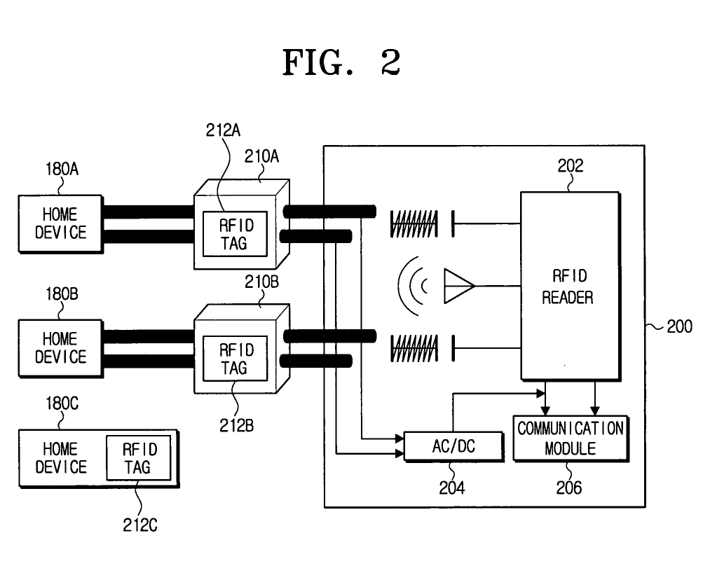

FIG. 2 is a diagram illustrating home devices (e.g., 180a, 180b, 180c) each of which have an RFID tag (e.g., 212a, 212b, 212c) thereon, and a plug receptacle 200 having an RFID reader 202, according to an exemplary embodiment of the invention. In FIG. 2, home device 180a has a plug 210a (on which RFID tag 212a is provided) which is connected to the plug receptacle 200 to provide power to the home device 180a. Alternatively, a home device 180c may be provided that does not have a plug, but which has an RFID tag 212c thereon. Other configurations may be provided according to a user setup mode. The RFID tags 212a, 212b, 212c each include information about the respective home devices 180a, 180b, 180c (e.g., a maker, kind, model, date, serial number, and web address of the home device).

The RFID reader 202 has a recognizing range, which is adjustable according to a user setup mode, wherein it is able to recognize an RFID tag. Further, the RFID reader 202 can recognize a location of RFID tag when the RFID reader 202 has a narrow recognizing range. In this embodiment, the RFID reader 202 controls the recognizing range to recognize the RFID tags 212a, 212b, 212c when they are located within 1 meter.

The RFID reader 202 receives the information about a home device (e.g., 180a, 180b, 180c) from the RFID tag (e.g., 212a, 212b, 212c) and transmits the received information to a communication module 206, which then transmits the received information, along with a plug receptacle identifier, to a communication module 306 of the home server. In addition, the communication module 206 receives plug insertion information that indicates whether the plug is inserted into the plug receptacle 200 or not. Namely, when the plug 210a is inserted into the plug receptacle 200, a power setup process is performed to apply power to both ends of the plug 210a, and to an AC/DC converter 204 through the plug. The AC/DC converter 204 converts AC power to DC power. The communication module 206 then receives the DC power and thereby recognizes whether the plug 210a is inserted into the plug receptacle 200.

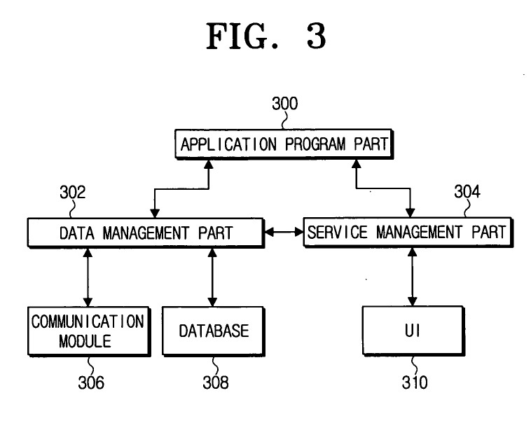

Hereinafter, elements of the home server and operations thereof will be described in detail. FIG. 3 illustrates each of the elements of the home server according to an exemplary embodiment of the invention. In FIG. 3, the home server includes an application program part 300, a data management part 302, a service management part 304, a communication module 306, a database (DB) 308, and a user interface (UI) 310.

The communication module 306 receives the information about the home device (e.g., 180a, 180b, 180c) and the plug receptacle identifier (i.e., identifying information) from the communication module 206 of the plug receptacle 200 and transmits the identifying information to the data management part 302. The data management part 302 analyzes the identifying information to classify home devices. This identifying information is stored in a database 308 by a command from the data management part 302. The following table 1 shows how the identifying information is stored in the database 308.

TABLE 1

| | | | plug | |
|---|---|---|---|---|
| home device | maker | serial number | receptacle number | location |
| coffeepot | A | 1234567890 | C-7 | kitchen |
| refrigerator | B | 9876543210 | C-9 | kitchen |
| . . . | . . . | . . . | . . . | . . . |
| TV | C | 4567891230 | C-3 | living room |

The service management part 304 controls the home devices by using the identifying information received from the data management part 302. Namely, the service management part 304 transmits necessary control commands to the data management part 302 in order to control the home devices by using the identifying information received from the data management part 302. The data management part 302 then transmits the received control commands to the communication module 306, which transmits the control commands to the corresponding home devices (e.g., 180a, 180b, 180c). A detailed description of the operation of the service management part 304 will be provided below.

The user interface 310 receives information from the user. Namely, the user transmits the location information of the plug receptacle 200 to the home server by using the user interface 310. The application program part 300 stores application programs which may be used to drive the home server, if necessary. In addition, the home server may receive information from a web address using the communication module 306.

In FIG. 3, the database 308 is directly connected to the data management part 302, however the database 308 can be connected to both of the data management part 302 and the service management part 304 or only the service management part 304, according to the user setup mode.

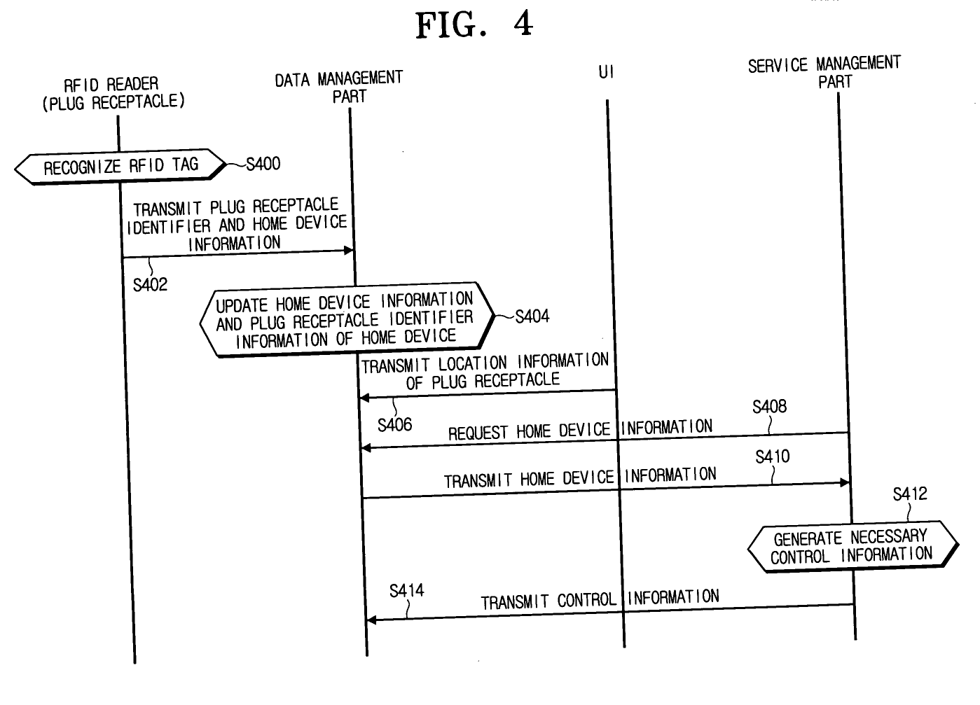

FIG. 4 is a flowchart illustrating operations performed between a plug receptacle 200 and a home server according to an exemplary embodiment of the invention. By referring to FIG. 4 and also to FIGS. 2 and 3, an information transmission process according to the exemplary embodiment of the invention will be described in detail.

In operation S400, the RFID reader 202 recognizes an RFID tag (e.g., 212a, 212b, 212c) and receives information about a home device (e.g., 180a, 180b, 180c) from the recognized RFID tag (e.g., 212a, 212b, 212c).

In operation S402, the RFID reader 202 transmits the received information about the home device, along with the identifier of the plug receptacle 200 to which a plug (e.g., 210a, 210b, 210c) is connected, to the data management part 302 using the communication modules 206, 306.

In operation S404, the data management part 302 updates the database 308 by using the received identifying information. Namely, the data management part 302 updates the database 308 by adding the received identifying information to the database 308.

In operation S406, the user interface 310 transmits the location information of the plug receptacle 200 to the data management part 302. As shown in FIG. 3, the user interface 310 transmits the location information of the plug receptacle 200 through the service management part 304, however the user interface 310 may transmit the location information of the plug receptacle 200 directly to the data management part 302 according to the user setup mode. Needless to say, the data management part 302 updates the database 308 by using the received location information of the plug receptacle 200.

In FIG. 4, the operation S404 is performed prior to the operation S406, however the operation S406 may be performed prior to the operation S404, according to the user setup mode. Namely, the operations of S400 to S404 and the operation S406 can be performed in any order, or simultaneously.

In operation S408, the service management part 304 requests the identifying information about the home devices (e.g., 180a, 180b, 180c) in order to control the home devices. In operation S410, the data management part 302 transmits the identifying information about the home devices requested by the service management part 304. However, the data management part 302 can transmit the identifying information about the home devices to the service management part 304 without the request of the service management part 304 in a constant time interval or a real-time interval.

In operation S412, the service management part 304 generates control information. Namely, the service management part 304 generates control information to control the home devices (e.g., 180a, 180b, 180c) by using the identifying information about the home devices.

In operation S414, the service management part 304 transfers the generated control information to the data management part 302. The data management part 302 then transfers the received control information to the home device (e.g., 180a, 180b, 180c), via the communication module 306. When the service management part 304 is connected with the communication module 306, the generated control information may be directly transferred to the communication module 306.

As an illustrative exemplary embodiment, a remote controller is provided for controlling a plurality of televisions, having different options, located at different spaces in a house. In this case, the remote controller has control information to control the televisions before they are arranged at the different spaces in the house. The remote controller is then configured to reset its control information to control the various televisions at the different spaces in the house.

At this time, if the remote controller (an example of a device 180c) having an RFID tag is moved to a new region, the RFID reader 202 located at the new region receives the information of the remote controller from the RFID tag thereon. The RFID reader 202 then transmits the received information to the home server (service management part), and the service management part 304 receives, from the data management part 302, the options of the televisions located at the new region. Then, the service management part 304 generates control information adapted to the options of the televisions, and transmits the generated control information to the remote controller (using its RFID tag). The remote controller then resets its control information by using the received control information for the television in the new region. By performing the described processes, the remote controller can reset the control information without the user's additional operation.

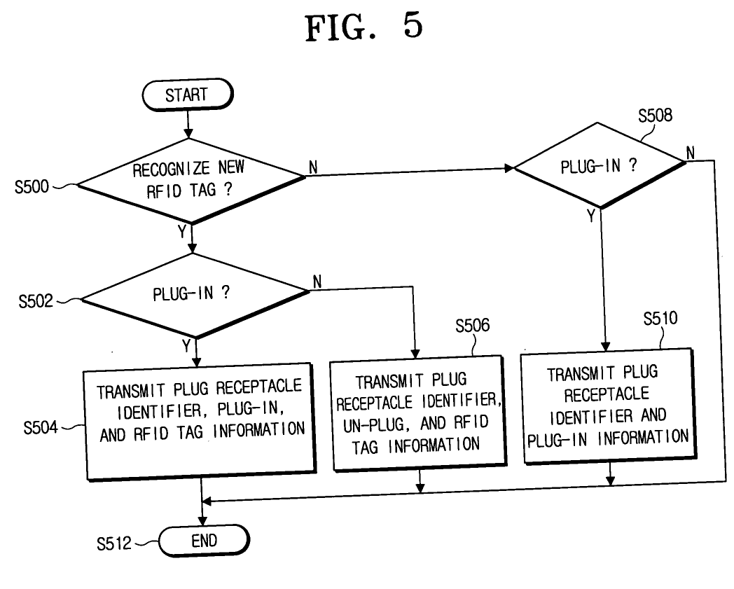

FIG. 5 shows operations of the plug receptacle 200 having the RFID reader 202 according to the exemplary embodiment of the prevent invention.

In operation S500, the plug receptacle 200 determines whether one of the RFID tags 212a, 212b or 212c is a new RFID tag (i.e., not registered with, or authenticated on, the network) or not. If a new RFID tag is detected, operation S502 is performed. If a new RFID tag is not detected (i.e., if the RFID tag is already registered), operation S508 is performed.

In the operation S502, the plug receptacle 200 determines whether the device on which the new RFID tag is provided is a plugged in to the plug receptacle 200 or not. In FIG. 2, devices 180a and 180b are plugged in to the plug receptacle, while device 180c is not. If the device on which the detected RFID tag is provided is plugged in, operation S504 is performed. If the device 180a on which the detected RFID tag is provided is not plugged in, operation S506 is performed.

In the operation S504, the plug receptacle 200 transmits the plug receptacle identifier, plugged in information indicating that the device is plugged in to the pug receptacle 200, and the RFID tag information to the home server.

In the operation S506, the plug receptacle 200 transmits the plug receptacle identifier and the RFID tag information to the home server.

In the operation S508, the plug receptacle 200 determines whether the device on which the already registered RFID tag is provided is plugged in to the plug receptacle 200 or not. If the device on which the already registered RFID tag is provided is plugged in, operation S510 is performed. If the device on which the detected RFID tag is provided is not plugged in operation S512 is performed.

In the operation S510, the plug receptacle 200 transmits the plug receptacle identifier, and plugged in information to the home server.

In the operation S514, the plug receptacle 200 transmits the plug receptacle identifier to the home server.

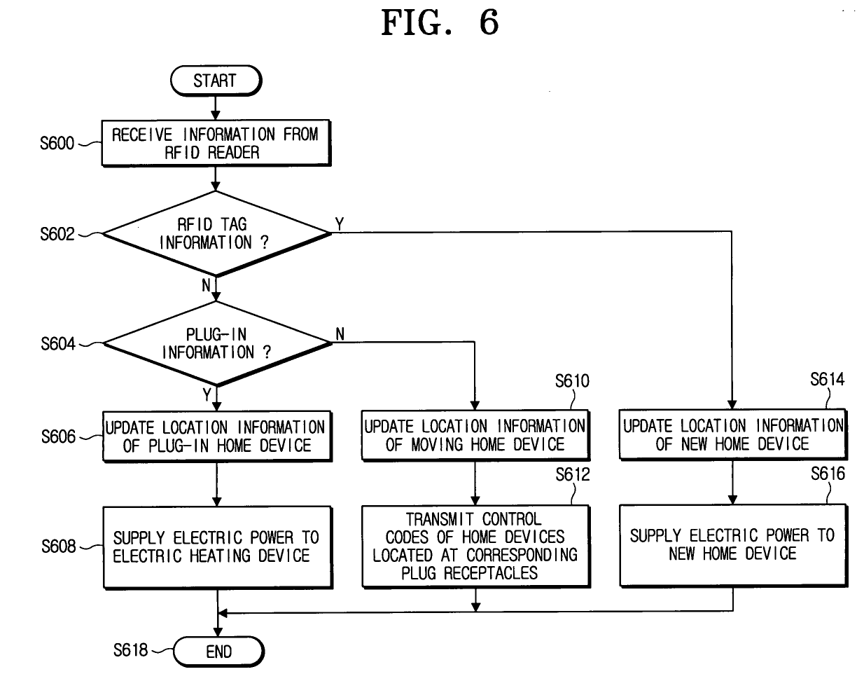

FIG. 6 shows operations of the home server according to the exemplary embodiment of the invention.

In the operation S600, the home server receives the information transmitted from the plug receptacle 200.

In the operation S602, the home server determines whether the information from the plug receptacle contains RFID tag information, or not. If RFID tag information is received, operation S614 is performed. If RFID tag information is not received, operation S604 is performed.

In the operation S604, the home server determines whether plugged in information is detected, or not. If plugged in information is detected, operation S606 is performed. If plugged in information is not detected, operation S610 is performed.

In the operation S606, the home server updates the location information of the plugged in home device. Namely, the home server updates the location information of the home device by using a received plug identifier.

In the operation S608, the home server gives a command to supply electric power to the plugged in home device. An example of such a home device is an electric heating device.

In the operation S610, the home server updates the location information of a movable home device (e.g., a device that does not need to be plugged in, such as the remote controller discussed above).

In the operation S612, the home server transmits control codes for various home devices, located around the plug receptacle 200, to the movable home device having an RFID tag.

In the operation S614, the home server updates the location information of the new home device.

In the operation S616, the home server gives a command to supply electric power to the new home device. The home server supplies the electric power to the new home device only when the device is authenticated through an authentication process of the home server. In this manner, unnecessary power consumption by the new home device is prevented when it is not authenticated.

As described above, the invention is related to adding RFID tags to home devices in order to recognize the locations of home devices included in the home network. Since the home server recognizes the locations of the home devices in the real-time interval, the home server can provide a desirable service to the user without the user's additional operation. In addition, when an unrecognized new home device enters into the home network, the home server can prevent unnecessary power consumption by the unrecognized new home device by performing a recognition process for the unrecognized new home device.

While this invention has been particularly shown and described with reference to exemplary embodiments thereof, the invention is not limited to the these embodiments. It will be understood by those of ordinary skill in the art that various changes in form and details may be made therein without departing from the spirit and scope of the invention as defined by the following claims.

What is claimed is:

1. A location recognition system for a home network, the location recognition system comprising:
a home device comprising a Radio Frequency Identification (RFID) tag which stores information about the home device; and
an RFID reader which is at a first position and reads the information about the home device from the RFID tag.

2. The location recognition system according to claim 1, wherein the information stored on the RFID tag comprises at least one of a maker, kind, model, date, and serial number of the home device.

3. The location recognition system according to claim 1, further comprising a plug receptacle, in which the RFID reader is arranged, comprising a communication module that transmits the information about the home device read from the RFID tag.

4. The location recognition system according to claim 3, wherein the communication module also transmits identification information of the plug receptacle, and an indication of whether the home device has a plug plugged into the plug receptacle.

5. The location recognition system according to claim 1, further comprising a home server which receives from the RFID reader the information about the home device read from the RFID tag.

6. The location recognition system according to claim 5, wherein the home server receives an identifier of an object to which the RFID reader is attached, and an indication of whether the home device has a plug plugged into the plug receptacle.

7. The location recognition system according to claim 6, wherein the object comprises a plug receptacle.

8. The location recognition system according to claim 1, further comprising a home server; and a plug receptacle, in which the RFID reader is arranged,
wherein the plug receptacle further comprises a communication module which transmits the information about the home device read by the RFID reader to the home server.

9. The location recognition system according to claim 8, wherein the communication module transmits identification information of the plug receptacle, and an indication of whether the home device has a plug plugged into the plug receptacle, to the home server.

10. The location recognition system according to claim 1, wherein the home device comprises a plug, on which the RFID tag is arranged.

11. The location recognition system according to claim 5, wherein the home server stores location information of the plug receptacle in the home network.

12. The location recognition system according to claim 8, wherein the home server stores location information of the plug receptacle in the home network.

13. The location recognition system according to claim 6, wherein the home server stores the information about the home device read from the RFID tag, and the identifier of the object to which the RFID reader is attached.

14. The location recognition system according to claim 13, wherein, if the home server recognizes movement of the home device by comparing a stored identifier of the object to which the RFID reader is arranged to the identifier of the object to which the RFID reader is arranged received from the RFID reader, the home server transmits a control code for controlling other home devices placed in a region where the home device is moved to.

15. The location recognition system according to claim 5, wherein the home server performs an authentication process with the home device when the information about the home device read from the RFID tag is read from an unauthenticated RFID tag.

16. The location recognition system according to claim 1, further comprising a home server which receives from the RFID reader the information about the home device read from the RFID tag, an identifier of an object to which the RFID reader is attached, and an indication of whether the home device has a plug plugged into the plug receptacle,
wherein, if the home server receives only the indication of whether the home device has a plug plugged into the plug receptacle, the home server does not supply a power to the home device.

17. The location recognition system according to claim 1, wherein, if information on the home device is required, the home server accesses a server storing the information on the home device.

18. The location recognition system according to claim 5, wherein the home server further comprises a service management part which transmits control commands to the home device.

19. A home server comprising:
a communication module communicating with a Radio Frequency Identification (RFID) reader; and
a database storing information about a home device obtained from an RFID tag on the home device via the RFID reader.

20. The home server according to claim 19, wherein the information from the RFID tag includes maker, kind, model, date, and serial number of the home device.

21. The home server according to claim 19, wherein the database further stores an identifier of a plug receptacle in which the RFID reader is arranged.

22. The home server according to claim 21, wherein the database further stores an indication of whether the home device has a plug plugged into the plug receptacle.

23. The home server according to claim 19, further comprising a service management part which controls the home device.

24. The home server according to claim 23, wherein the service management part controls the home device according to the information about the home device stored in the database.

25. The home server according to claim 19, wherein the database stores location information of the plug receptacle in the home network.

26. The home server according to claim 21, further comprising a service management part which controls the home device,
wherein, if the service management part recognizes movement of the home device by comparing a stored identifier of the object to which the RFID reader is arranged to an identifier of the object to which the RFID reader is arranged received from the RFID reader, the service management part transmits a control code for controlling other home devices placed in a region where the home device is moved to.

27. The home server according to claim 23, wherein, if the RFID tag is unauthenticated, the service management part performs an authentication process with the home device.

28. The home server according to claim 19, wherein:
the database stores the information about the home device read from the RFID tag, an identifier of an object to which the RFID reader is attached, and an indication of whether the home device has a plug plugged into the plug receptacle; and
if only the indication of whether the home device has a plug plugged into the plug receptacle is stored, the service management part does not supply a power to the home device.
